(19) United States
(12) Patent Application Publication
(10) Pub. No.: US 2023/0090419 A1
(43) Pub. Date: Mar. 23, 2023

(54) APPARATUS AND METHOD FOR RECORDING A HOLOGRAPHIC OPTICAL ELEMENT

(71) Applicant: Robert Bosch GmbH, Stuttgart (DE)

(72) Inventors: Tobias Graf, Überlingen (DE); Reinhold Fiess, Durbach (DE); Simone Hoeckh, Renningen (DE)

(21) Appl. No.: 17/897,029

(22) Filed: Aug. 26, 2022

(30) Foreign Application Priority Data
Sep. 20, 2021 (DE) 10 2021 210 377.4

(51) Int. Cl. G03H 1/04

(52) U.S. Cl. CPC G03H 1/0402; G03H 2001/0439

(57) ABSTRACT

An apparatus and method for recording a holographic optical element. The apparatus includes a first recording unit configured to provide a first wave front for recording the holographic optical element, a second recording unit configured to provide a second wave front for recording the holographic optical element, and (i) a deformable phase plate configured to perform wave front modulation of the first wave front when the holographic optical element is recorded, or (ii) a plurality of deformable phase plates, at least one deformable phase plate (of the plurality of deformable phase plates can be configured to perform wave front modulation of the first wave front when the holographic optical element is recorded.

### CROSS REFERENCE

The present application claims the benefit under 35 U.S.C. § 119 of German Patent Application No. DE 10 2021 210 377.4 filed on Sep. 20, 2021, which is expressly incorporated herein by reference in its entirety.

### FIELD

The present invention relates to an apparatus and a method for recording a holographic optical element.

### BACKGROUND INFORMATION

The generation of holographic optical elements requires two coherent wave fronts. Providing complex wave fronts requires very elaborate free-form optics and/or adaptive optical elements.

Adaptive optical elements for wave front modulations can be produced using spatial light modulators (SLM) based, for example, on liquid crystal on silicon (LCOS) or deformable mirrors, in particular MEMS mirrors. However, the use of these elements requires an elaborate arrangement of the elements in order to, for example, avoid effects, because the work must be done with adaptive optical elements in reflections and under oblique angles.

### SUMMARY

The recording of a holographic optical element by the apparatus and the method according to the present invention is improved in that the occurrence of the effects is avoided without such an elaborate arrangement.

According to an example embodiment of the present invention, the apparatus for recording a holographic optical element comprises a first recording unit configured to provide a first wave front for recording the holographic optical element, wherein the apparatus comprises a second recording unit configured to provide a second wave front for recording the holographic optical element, wherein the apparatus comprises a deformable phase plate, wherein the deformable phase plate is configured to perform wave front modulation of the first wave front when the holographic optical element is recorded, or wherein the apparatus comprises a plurality of deformable phase plates, wherein at least one deformable phase plate of the plurality of deformable phase plates can be configured to perform wave front modulation of the first wave front when the holographic optical element is recorded. This apparatus has a simplified beam path. As a result, an apparatus in which LCOS SLMs in at least one recording arm can be replaced by more cost-efficient deformable phase plates is provided for a recording method. This results in a simpler, less alignment-sensitive, and more cost-efficient optical system.

According to an example embodiment of the present invention, it may be provided that the deformable phase plate or at least one deformable phase plate of the plurality of deformable phase plates is designed and/or can be controlled for wave front modulations in order to avoid wave front modulators in a reflection. As a result, an apparatus with which wave front modulators in reflection can be avoided in order to suppress aberrations is provided for a recording method.

According to an example embodiment of the present invention, it may be provided that the apparatus comprises the plurality of deformable phase plates, wherein at least one deformable phase plate of the plurality of deformable phase plates is arranged in a beam path of the second wave front and can be configured to perform wave front modulation of the second wave front when the holographic optical element is recorded. As a result, an apparatus which has a simplified beam path in its two recording arms is provided for multi-target optimization of the holographic optical element.

According to an example embodiment of the present invention, it may be provided that the apparatus comprises the plurality of deformable phase plates, wherein several deformable phase plates are arranged in the beam path of the first wave front, in particular cascaded one behind the other in the direction of the beam path of the first wave front, and/or wherein several deformable phase plates are arranged in the beam path of the second wave front, in particular cascaded one behind the other in the direction of the beam path of the second wave front. As a result, more complex or stronger wave front modulations can be realized.

Preferably, according to an example embodiment of the present invention, the apparatus comprises a unit for controlling at least one deformable phase plate configured to perform wave front modulations by means of at least one deformable phase plate when the holographic optical element is recorded.

For example, the unit for controlling is configured to perform wave front modulations, which allow for a monochromatic and/or polychromatic holographic optical element to be recorded.

Aberrations through oblique lighting at the wave front modulator can thus be avoided.

According to an example embodiment of the present invention, the method for recording a holographic optical element comprises: providing a first wave front for recording the holographic optical element with a first recording unit, providing a second wave front for recording the holographic optical element with a second recording unit, performing wave front modulation of the first wave front when the holographic optical element is recorded, with a deformable phase plate arranged in a beam path of the first wave front when the holographic optical element is recorded, or performing wave front modulation of the first wave front when the holographic optical element is recorded, with a plurality of deformable phase plates arranged in a beam path of the first wave front when the holographic optical element is recorded. This represents a method for the production of a holographic optical element, which method is improved in at least one beam path.

According to an example embodiment of the present invention, it may be provided that the method comprises: controlling the deformable phase plate or at least one deformable phase plate of the plurality of deformable phase plates for wave front modulations in order to avoid reflective wave front modulators when the holographic optical element is recorded. This avoids aberrations.

According to an example embodiment of the present invention, it may be provided that the method comprises: performing wave front modulation of the second wave front when the holographic optical element is recorded, with at least one deformable phase plate arranged in the beam path of the second wave front when the holographic optical element is recorded. This provides a recording method that is simplified in both recording arms.

According to an example embodiment of the present invention, it may be provided that the method comprises: controlling several deformable phase plates when the holographic optical element is recorded, said phase plates being arranged in the beam path of the first wave front, in particular cascaded one behind the other in the direction of the beam path of the first wave front, when the holographic optical element is recorded, and/or controlling several deformable phase plates when the holographic optical element is recorded, said phase plates being arranged in the beam path of the second wave front, in particular cascaded one behind the other in the direction of the beam path of the second wave front, when the holographic optical element is recorded. This achieves complex or stronger wave front modulations.

According to an example embodiment of the present invention, it may be provided that the method comprises: controlling at least one deformable phase plate to perform wave front modulations when the holographic optical element is recorded, which allow for a monochromatic and/or polychromatic holographic optical element to be recorded. Aberrations through oblique lighting at the wave front modulator are thus avoided.

Further embodiments of the present invention can be taken from the following description and the figures.

### BRIEF DESCRIPTION OF THE DRAWINGS

FIG. 1A shows a schematic illustration of a first embodiment of an apparatus for recording a holographic optical element, according to the present invention.

FIG. 1B shows a schematic illustration of a second embodiment of the apparatus for recording the holographic optical element, according to the present invention.

FIG. 1C shows a schematic illustration of a third embodiment of the apparatus for recording a holographic optical element, according to the present invention.

FIG. 1D shows a schematic illustration of a fourth embodiment of the apparatus for recording a holographic optical element, according to the present invention.

FIG. 2 shows a schematic illustration of steps of a recording method for recording the holographic optical element, according to an example embodiment of the present invention.

### DETAILED DESCRIPTION OF EXAMPLE EMBODIMENTS

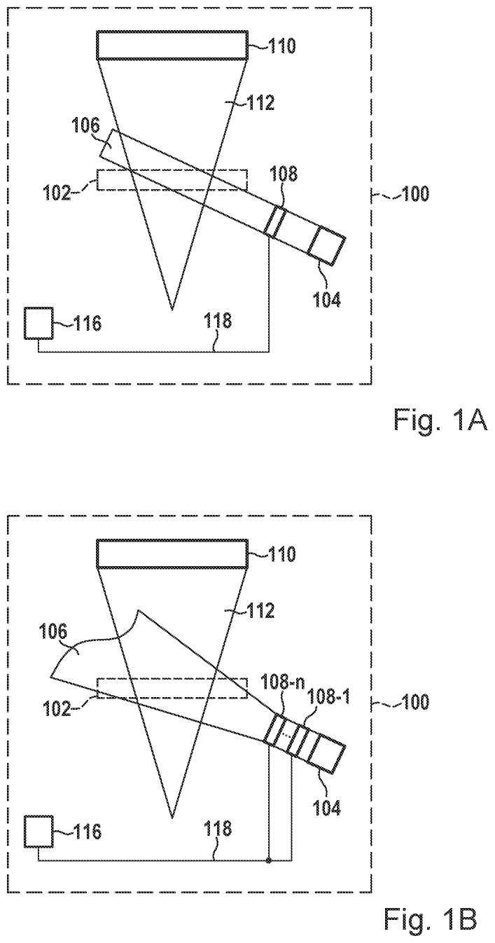

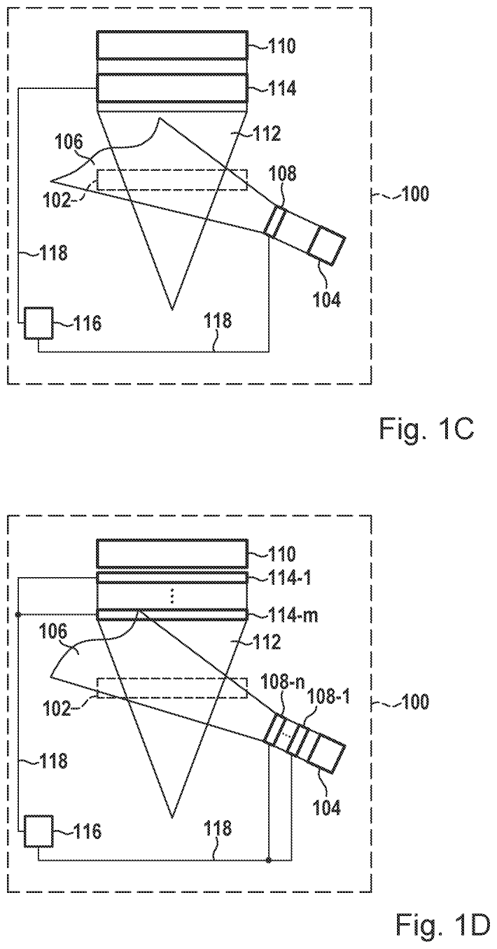

FIG. 1A schematically shows a first embodiment of an apparatus 100 for recording a holographic optical element 102.

The apparatus 100 comprises a first recording unit 104.

The first recording unit 104 is configured to provide a first wave front 106 for recording the holographic optical element 102. In the example, the first wave front 106 is a diverging spherical wave.

In the first embodiment, the apparatus 100 comprises a deformable phase plate 108 arranged in a beam path of the first wave front 106. The deformable phase plate 108 is configured to perform wave front modulation of the first wave front 106 when the holographic optical element 102 is recorded. This means that the wave fronts can be changed and adapted. For example, the diverging spherical wave is changed with the deformable phase plate 108 in such a way that a resulting wave front essentially moves toward the holographic optical element 102 without further diverging and without further converging.

The apparatus 100 comprises a second recording unit 110.

The second recording unit 110 is configured to provide a second wave front 112 for recording the holographic optical element 102. In the example, the second wave front 112 is a converging spherical wave.

The first embodiment of the apparatus 100 is designed without a deformable phase plate in the beam path of the second wave front 112.

FIG. 1B schematically shows a second embodiment of the apparatus 100 for recording the holographic optical element 102.

The apparatus 100 comprises the first recording unit 104 and the second recording unit 110.

In the second embodiment, the apparatus 100 comprises a plurality of n deformable phase plates 108-1, . . . , 108-n arranged in the beam path of the first wave front 106. The plurality of deformable phase plates 108-1, . . . , 108-n is configured to perform wave front modulation of the first wave front 106 when the holographic optical element 102 is recorded.

The second embodiment of the apparatus 100 is designed without a deformable phase plate in the beam path of the second wave front 112.

FIG. 1C schematically shows a third embodiment of the apparatus 100 for recording the holographic optical element 102.

The apparatus 100 comprises the first recording unit 104 and the second recording unit 110.

In the third embodiment, the apparatus 100 comprises the deformable phase plate 108 arranged in the beam path of the first wave front 106. The deformable phase plate 108 is configured to perform wave front modulation of the first wave front 106 when the holographic optical element 102 is recorded.

In the third embodiment, the apparatus 100 comprises a deformable phase plate 114 arranged in the beam path of the second wave front 112. The deformable phase plate 114 is configured to perform wave front modulation of the second wave front 112 when the holographic optical element 102 is recorded.

FIG. 1D schematically shows a fourth embodiment of the apparatus 100 for recording the holographic optical element 102.

The apparatus 100 comprises the first recording unit 104 and the second recording unit 110.

In the fourth embodiment, the apparatus 100 comprises the plurality of n deformable phase plates 108-1, . . . , 108-n arranged in the beam path of the first wave front 106. The plurality of deformable phase plates 108-1, . . . , 108-n is configured to perform wave front modulation of the first wave front 106 when the holographic optical element 102 is recorded.

In the fourth embodiment, the apparatus 100 comprises a plurality of m deformable phase plates 114-1, . . . , 114-m arranged in the beam path of the second wave front 112. The plurality of deformable phase plates 114-1, . . . , 114-m is configured to perform wave front modulation of the second wave front 112 when the holographic optical element 102 is recorded.

In the example, the apparatus 100 comprises a unit 116 for controlling at least one of the deformable phase plates. One or more control lines 118 are respectively provided in the example for this purpose.

In the example, the unit 116 is configured to perform wave front modulations by means of at least one of the deformable phase plate when the holographic optical element 102 is recorded.

In the example, the unit 116 is configured to perform wave front modulations, which allow for a monochromatic and/or polychromatic holographic optical element 102 to be recorded.

The deformable phase plates are, for example, designed as described in Pouya Rajaeipour, Kaustubh Banerjee, Alex Dorn, Hans Zappe, and Cağlar Ataman “Cascading optofluidic phase modulators for performance enhancement in refractive adaptive optics,” Advanced Photonics 2(6), 066005 (Nov. 18, 2020).

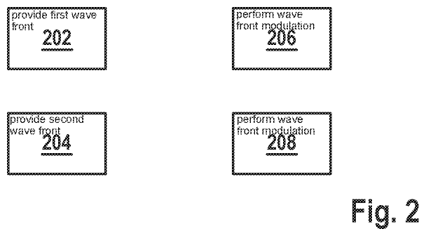

FIG. 2 shows possible steps in a recording method for recording the holographic optical element 102.

Providing 202 a first wave front 106 for recording the holographic optical element 102 with a first recording unit 104.

Providing 204 a second wave front 110 for recording the holographic optical element 102 with a second recording unit 110.

Performing 206 wave front modulation of the first wave front 106 when the holographic optical element 102 is recorded.

The method may also provide for wave front modulation of the second wave front to be performed 208 when the holographic optical element is recorded.

It may be provided for the wave front modulation of the first wave front 106 to be performed with the deformable phase plate 108 or with the plurality of deformable phase plates 108-1, . . . , 108-n.

In the example, depending on the embodiment of the apparatus, either the deformable phase plate 108 or at least one of the deformable phase plates of the plurality of deformable phase plates 108-1, . . . , 108-n is controlled for wave front modulations while the holographic optical element 102 is recorded.

It may be provided for the wave front modulation of the second wave front 112 to be performed with the deformable phase plate 114 or with the plurality of deformable phase plates 114-1, . . . , 114-m.

In the example, depending on the embodiment of the apparatus, either the deformable phase plate 114 or at least one of the deformable phase plates of the plurality of deformable phase plates 114-1, . . . , 114-m is controlled for wave front modulations while the holographic optical element 102 is recorded.

In the example, controlling takes place in order to avoid wave front modulators in a reflection and in order to allow for a monochromatic and/or polychromatic holographic optical element 102 to be recorded.

The method may provide for specifically recording the holographic optical element 102 for augmented reality smartglasses or data glasses. The method may provide for specifically recording the holographic optical element 102 for front and side window projection in a vehicle interior. The method may provide for recording the holographic optical element 102 for a specific optical design of holographic displays and holographic optical elements. The method may provide for recording the holographic optical element 102 in a retina scanner display with the goal of multi-target optimization of the holographic optical element 102 for expanding an exit pupil (exit pupil expansion, EPE), i.e., an enlargement of an eye box.

What is claimed is:

1. An apparatus for recording a holographic optical element, comprising:
a first recording unit configured to provide a first wave front for recording the holographic optical element;
a second recording unit configured to provide a second wave front for recording the holographic optical element; and
(i) a deformable phase plate configured to perform wave front modulation of the first wave front when the holographic optical element is recorded, or (ii) a plurality of deformable phase plates, wherein at least one deformable phase plate of the plurality of deformable phase plates is configurable to perform wave front modulation of the first wave front when the holographic optical element is recorded.

2. The apparatus as recited in claim 1, wherein the deformable phase plate or at least one deformable phase plate of the plurality of deformable phase plates is configured and/or can be controlled for wave front modulations to avoid wave front modulators in a reflection.

3. The apparatus as recited in claim 1, wherein the apparatus comprises the plurality of deformable phase plates, wherein at least one deformable phase plate of the plurality of deformable phase plates is arranged in a beam path of the second wave front and is configurable to perform wave front modulation of the second wave front when the holographic optical element is recorded.

4. The apparatus as recited in claim 1, wherein the apparatus comprises the plurality of deformable phase plates, wherein in a beam path of the first wave front, several deformable phase plates are arranged, cascaded one behind the other in a direction of the beam path of the first wave front, and/or wherein in a beam path of the second wave front, several deformable phase plates are arranged, cascaded one behind the other in a direction of the beam path of the second wave front.

5. The apparatus as recited in claim 1, further comprising:
a unit configured to control at least one deformable phase plate configured to perform wave front modulations using the at least one deformable phase plate when the holographic optical element is recorded.

6. The apparatus as recited in claim 5, wherein the unit configured to control is configured to perform wave front modulations, which allow for a monochromatic and/or polychromatic holographic optical element to be recorded.

7. A method for recording a holographic optical element, comprising the following steps:
providing a first wave front for recording the holographic optical element, using a first recording unit;
providing a second wave front for recording the holographic optical element, using a second recording unit; and
(i) performing wave front modulation of the first wave front when the holographic optical element is recorded, using a deformable phase plate arranged in a beam path of the first wave front, when the holographic optical element is recorded, or (ii) performing wave front modulation of the first wave front when the holographic optical element is recorded, using a plurality of deformable phase plates arranged in the beam path of the first wave front when the holographic optical element is recorded.

8. The method as recited in claim 7, further comprising:
controlling the deformable phase plate or at least one deformable phase plate of the plurality of deformable phase plates to perform wave front modulations when the holographic optical element is recorded, to avoid wave front modulators in a reflection.

9. The method as recited in claim 7, further comprising:
performing wave front modulation of the second wave front when the holographic optical element is recorded, using at least one deformable phase plate arranged in a beam path of the second wave front when the holographic optical element is recorded.

10. The method as recited in claim 7, further comprising:
(i) controlling several deformable phase plates when the holographic optical element is recorded, the phase plates being arranged in a beam path of the first wave front, cascaded one behind the other in a direction of the beam path of the first wave front, when the holographic optical element is recorded, and/or (ii) controlling several deformable phase plates when the holographic optical element is recorded, the phase plates being arranged in a beam path of the second wave front, cascaded one behind the other in a direction of the beam path of the second wave front, when the holographic optical element is recorded.

11. The method as recited in claim 10, further comprising:
controlling at least one deformable phase plate to perform wave front modulations when the holographic optical element is recorded, which allow for a monochromatic and/or polychromatic holographic optical element to be recorded.
